(19) United States
(12) Patent Application Publication
(10) Pub. No.: US 2007/0159127 A1
(43) Pub. Date: Jul. 12, 2007

(54) Arrangement for determining and controlling the position of a convertible top

(76) Inventors: Tobias Wagner, Hamburg (DE); Frank Haltermann, Heidenau (DE)

Correspondence Address: JORDAN AND HAMBURG LLP, 122 EAST 42ND STREET, SUITE 4000, NEW YORK, NY, 10168, US

(21) Appl. No.: 11/651,285

(22) Filed: Jan. 9, 2007

(30) Foreign Application Priority Data
Jan. 9, 2006 (DE) DE102006001 472.3

(51) Int. Cl. G05B 1/06

(52) U.S. Cl. 318/663

(57) ABSTRACT

An arrangement for determining and controlling the position of a convertible top includes a potentiometer, a control unit and a top kinematic system motor. The potentiometer is able to register signals that are transmitted to the control unit, and the top kinematic system motor can be adjusted by the control unit. An arrangement for determining and controlling the position of a convertible top avoids the disadvantages of the state of the art by using a potentiometer that is a film potentiometer.

### BACKGROUND OF THE INVENTION

This invention relates to an arrangement for determining and controlling the position of a convertible top.

The convertible tops according to current technology are equipped with drive units that allow a fully automatic actuation. For this purpose, motors for the different single motions are arranged in the kinematic system and controlled via an electronic circuit.

Thus, DE 101 11 705 A1 describes a convertible system with complex multijoint kinematic elements that are normally driven by hydraulic cylinders and transmit the rotational motions by means of guiding rods to the parts of the top that are to be moved.

According to EP 1 160 113 A2, electrically or hydraulically driven swivel motors are used as actuators and are fixed in the main bearing at the body and/or are arranged at important joint points between the rigid top parts in such a way that they can be moved.

DE 199 52 590 A1 describes an arrangement for determining and controlling the position of a convertible top that reliably and precisely registers the position of the movable hydraulic elements and consequently of the top. For this purpose, a sensor designed as a restrictive displacement transducer is assigned to each hydraulic element and is integrated into the hollow-drilled piston rod of the piston of the hydraulic cylinder. The change in the output signal (change in the output voltage) is evaluated by a control unit.

DE 199 18 628 A1 reports about a kinematic top system based on piston rod transmission with the articulated lever position of said kinematic system being detected by sensing microswitches or potentiometers and transmitted in the form of signals to a microprocessor that controls the extending and retracting motions of the piston rod. U.S. Pat. No. 5,225,747 A describes an arrangement including measuring equipment that is designed as a sensor and installed on a rotational axis with said measuring equipment being used for determining and controlling the position of a convertible top.

All the measuring equipment heretofore known have the disadvantages that they require a large installation space in the top kinematic systems, although the space available is extremely reduced, and that they are susceptible to failure due to their design. Moreover, the casing of most of the measuring equipment is made of synthetic material so that these arrangements imply high risks of damage during their assembly and during the operation of the top, with the consequential risk that the top will be further actuated if the sensors are damaged.

It is the object of this invention to provide an arrangement for determining and controlling the position of a convertible top that avoids the above mentioned disadvantages.

### SUMMARY OF THE INVENTION

According to this invention, this task is fulfilled by an arrangement for determining and controlling the position of a convertible top which includes a film potentiometer, a control unit, and a kinematic system motor, wherein the film potentiometer is used to register and transmit signals to the control unit, and the kinematic system motor is adjustable by the control unit.

An arrangement for determining and controlling the position of a convertible top in accordance with the invention is made of a thin-film potentiometer that is installed on the rotational axis of one part of the convertible top, and a control unit that registers and evaluates the change in the output signal (change in the output voltage) of the film potentiometer and intervenes in a controlling and adjusting manner.

A special advantage of said arrangement is the fact that the thin-film potentiometer is installed between guiding rods.

In the following, the invention is explained in more detail by means of schematic drawings.

### BRIEF DESCRIPTION OF THE DRAWINGS

FIG. 1a depicts a first embodiment of the inventive arrangement for determining and controlling the position of a convertible top in a schematic side view;

FIG. 1b depicts the embodiment of the inventive arrangement according to FIG. 1a in a sectional drawing,

FIG. 2 depicts a second embodiment of the inventive arrangement in a sectional drawing; and

FIG. 3 depicts a third embodiment of the inventive arrangement in a sectional drawing.

### DETAILED DESCRIPTION OF THE INVENTION

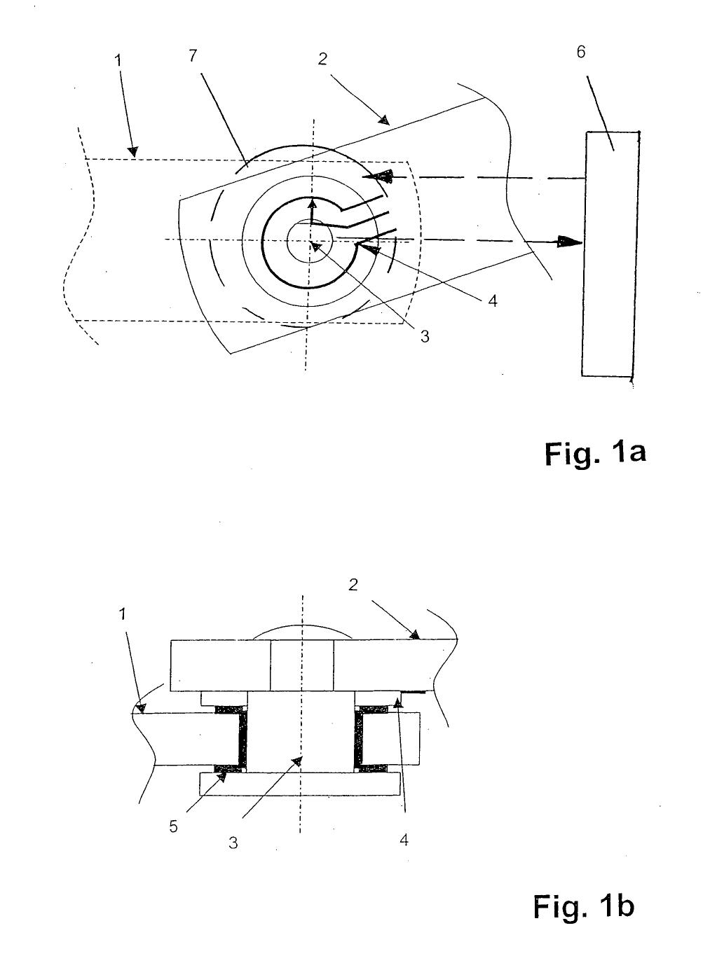

The arrangement for determining and controlling the position of a convertible top shown in FIG. 1 consists of a foil potentiometer 4 that is arranged like a ring around a rotational axis 3 of a convertible top part and connects a first guiding rod 1 and a second guiding rod 2, with said foil potentiometer 4 being fixed at the guiding rod 1 or the guiding rod 2 and being connected via a signal line with a control unit 6 that registers and evaluates the change in the output signal (change in the output voltage) of the film potentiometer 4, and intervenes into the motion of the kinematic motor 7 by controlling and adjusting said motion.

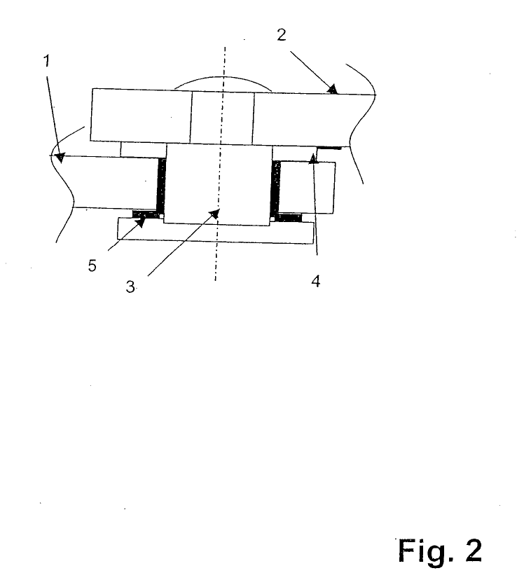

Unloaded, the foil potentiometer 4 can be connected with a bearing bush 5 (represented in FIG. 1b), or it can be an integral element of a bearing bush 5 (shown in FIG. 2) that has the rotational axis 3.

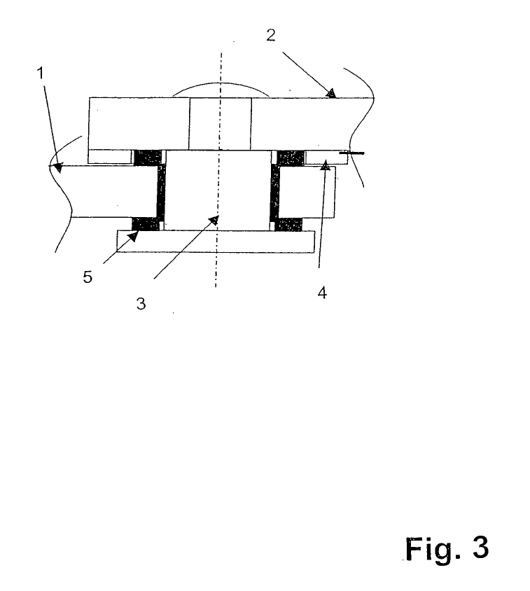

Alternatively, the ring-shaped film potentiometer 4 without load can be arranged like an external ring around the bearing bush 5 (shown in FIG. 3). Preferentially, the inventive film potentiometer has a thickness of about 1 mm or less and is, for example, arranged on the rotational axis of one part of the top.

Due to the change of the resistance of the film potentiometer 4 during the rotational motion of one axis of the top kinematic system, signals are permanently transmitted to the control unit 6 that evaluates the change of the signal and intervenes into the motion sequence of the motor 7 of the top kinematic system, e.g., an electric motor, by controlling and adjusting actions thereof.

Particularly, by virtue of the advantageous position of the film potentiometer 4 between the guiding rods 1 and 2, which move towards each other, the film potentiometer is not subject to the risk of being damaged. Since the potentiometer 4 is designed as a flexible film, its breakage is excluded during the assembly or the motion of the convertible top. In turn, this advantage avoids malfunctions of the top that are caused by damaged sensors. Simultaneously, the film potentiometer 4 of the inventive arrangement for the determination and control of the position of a convertible top does not require additional installation space. The individual features invention, and the figures are inclusive is defined by the claims.

### LIST OF REFERENCE NUMERALS

1—first guiding rod
2—second guiding rod
3—rotational axis
4—film potentiometer
5—bearing bush
6—control unit
7—top kinematic system motor

1-7. (canceled)

8. An arrangement for determining and controlling the position of a convertible top, comprising:
a film potentiometer;
a control unit; and
a kinematic system motor, said film potentiometer being used to register and transmit signals to said control unit, and said kinematic system motor being adjustable by said control unit.

9. An arrangement for determining and controlling the position of a convertible top according to claim 8, wherein said film potentiometer is installed between first and second guiding rods.

10. An arrangement for determining and controlling the position of a convertible top according to claim 9, wherein said film potentiometer is part of a guiding bush via which the first guiding rod is connected with a rotational axis so that it can be rotated and said rotational axis is fixed to the second guiding rod.

11. An arrangement for determining and controlling the position of a convertible top according to claim 9, wherein said film potentiometer is ring-shaped.

12. An arrangement for determining and controlling the position of a convertible top according to claim 10, wherein said film potentiometer is arranged in a manner of a ring around an external wall of said guiding bush via which said first guiding rod is connected with said rotational axis so that it is able to rotate and said rotational axis is fixed to said second guiding rod.

13. An arrangement for determining and controlling the position of a convertible top according to claim 8, wherein said film potentiometer is made of a flexible material.

14. An arrangement for determining and controlling the position of a convertible top according to claim 8, wherein the thickness of said film potentiometer is less than 1 mm.
